(19) United States
(12) Patent Application Publication
(10) Pub. No.: US 2012/0224227 A1
(43) Pub. Date: Sep. 6, 2012

(54) PRINT CONTROL DEVICE, PRINT CONTROL METHOD, AND PRINT CONTROL PROGRAM

(75) Inventor: Hirofumi Kukino, Kagoshima-shi (JP)

(73) Assignee: SEIKO EPSON CORPORATION, Tokyo (JP)

(21) Appl. No.: 13/409,723

(22) Filed: Mar. 1, 2012

(30) Foreign Application Priority Data
Mar. 2, 2011 (JP) 2011-044790

(51) Int. Cl. H04N 1/405

(52) U.S. Cl. 358/3.06

(57) ABSTRACT

A print control device which controls a printing device to print a plurality of images on a long sheet-shaped print substrate includes a halftone switching section that switches between a dither method and an error diffusion method to be performed during halftone processing, and a halftone processing section that subjects first image data and second image data to the halftone processing, wherein the halftone processing section controls an initializing procedure for the second image data during the halftone processing, on the basis of a combination of the respective switched methods for the first image data and the second image data.

### BACKGROUND

1. Technical Field

The present invention relates to a print control device, a print control method, and a print control program.

2. Related Art

In recent years, inkjet printers have been widely used for printing images with multiple colors and tones which a printer host, such as a computer, has processed. An inkjet printer performs image processing (so-called “halftone processing”) before printing an image. In this image processing, the different tones in an original image are expressed by varying the diffusion of dots. For example, JP-A-2002-283620 discloses an image processing method in which if it is determined that an image needs to be printed on a print substrate with high quality, then halftone processing employing an error diffusion method is performed, so that a high quality printed image is provided. Meanwhile, if it is determined that high-quality printing is unnecessary, then a simple halftone processing employing a dither method is performed, so that the print time is shortened.

However, in the above-mentioned image processing method, printing of multiple images in series on a long sheet-shaped print substrate, such as a roll of paper, is not considered. For example, when multiple images are printed on such a roll of paper in series by means of the halftone processing employing the error diffusion method, the errors contained in the preceding printed image may affect the quality of the following printed image. In order to avoid this, a process of initializing the errors contained in the printed image every time a new image is printed is conceivable. However, this initialization processing may deteriorate the throughput of the entire print processing.

### SUMMARY

An advantage of some aspects of the invention is that it is possible to solve at least part of the above-mentioned disadvantage, and embodiments of the invention may be implemented by the following applications.

### APPLICATION EXAMPLE 1

According to an application example 1 of the invention, a print control device for controlling a printing device to print a plurality of images on a long sheet-shaped print substrate includes an image acquisition section that acquires first image data and second image data, a halftone switching section that switches between a dither method and an error diffusion method to be performed during halftone processing, a halftone processing section that subjects the first image data and the second image data to the halftone processing, and an output section that causes the printing device to print a first image and a second image on the print substrate in this sequence, wherein the first image and the second image are arranged adjacent to each other in a transporting direction of the print substrate, and the first and second images are formed by subjecting the first and second image data to the halftone processing, respectively. Further, the halftone processing section controls an initializing procedure for the second image data during the halftone processing, on the basis of a combination of the respective switched methods for the first image data and the second image data.

As described above, in the print control device, the halftone switching section switches between the dither method and the error diffusion method to be performed during the halftone processing, before the images are printed on the long sheet-shaped print substrate. In addition, the halftone processing section controls an initializing procedure for the second image data during the halftone processing, on the basis of a combination of the respective switched methods for the first image data to be printed first and the second image data to be printed after and adjacent to the first image data. Since the initializing procedure is controlled on the basis of the combination of the dither method and the error diffusion method during the halftone processing, the initializing procedure can be omitted, for example, when the combination of the methods makes the initializing procedure decrease the process speed. This prevents the throughput of the entire printing processing from being deteriorated.

### APPLICATION EXAMPLE 2

According to an application example 2 of the invention, the halftone processing section skips the initializing procedure for the second image data during the halftone processing, if both of the switched methods for the first image data and the second image data are the error diffusion methods.

As described above, the print control device skips the initializing procedure, when performing the error diffusion method during the halftone processing in series. This prevents the throughput of the entire printing processing from being deteriorated.

### APPLICATION EXAMPLE 3

According to an application example 3 of the invention, the print control device further includes a cut control section that causes the printing device to cut the print substrate in a direction that intersects the transporting direction. Specifically, the cut control section causes the printing device to cut a border between the first and second images twice while reserving a predetermined interval in the transporting direction. In addition, the predetermined interval is set to be larger than that set if the halftone processing section does not employ the error diffusion methods for both of the first image data and the second image data during the halftone processing.

As described above, the print control device sets the cut intervals, such that the cut interval between images which have been subjected to the error diffusion method in series is larger than the cut interval between images which have not. This makes it possible to prevent the error generated upon printing the preceding image from affecting the print quality of the following image, even when the error diffusion method is applied consecutively to images during the halftone processing.

### APPLICATION EXAMPLE 4

According to an application example 4 of the invention, the halftone switching section switches to the error diffusion method, if target image data for the halftone processing contains data to be printed with high quality. Meanwhile, the halftone switching section switches to the dither method, if the target image data does not contain data to be printed with high quality.

As described above, when determining that a target image needs to be printed on a long sheet-shaped print substrate with high quality, the print control device performs the halftone processing employing the error diffusion method, for the purpose of providing high-quality printing. Meanwhile, when not determining that a target image needs to be printed with high quality, the print control device performs the simple halftone processing employing the dither method, for the purpose of increasing the printing speed.

### APPLICATION EXAMPLE 5

According to an application example 5 of the invention, a print control method of controlling a printing device to print a plurality of images on a sheet-shaped print substrate, which includes acquiring first image data and second image data, switching between a dither method and an error diffusion method to be performed during halftone processing, subjecting the first image data and the second image data to the halftone processing, and causing the printing device to print a first image and a second image on the print substrate in this sequence, wherein the first image and the second image are arranged adjacent to each other in a transporting direction of the print substrate, and the first and second images are formed by subjecting the first and second image data to the halftone processing, respectively. Further, the halftone processing section controls an initializing procedure for the second image data during the halftone processing, on the basis of a combination of the respective switched methods for the first image data and the second image data.

As described above, the print control method switches between the dither method and the error diffusion method to be performed during the halftone processing, in order to print on a sheet-shaped print substrate. In addition, the halftone processing section controls an initializing procedure for the second image data in the halftone processing step, on the basis of a combination of the respective switched methods for the first image data to be printed first and the second image data to be printed after and adjacent to the first image data. Since the initializing procedure is controlled on the basis of the combination of the dither method and the error diffusion method during the halftone processing, the initializing procedure can be omitted, for example, when the combination of the methods makes the initializing procedure decrease the process speed. This prevents the throughput of the entire printing processing from being deteriorated.

### APPLICATION EXAMPLE 6

According to an application example 6 of the invention, a print control program for controlling a printing device to print a plurality of images on a long sheet-shaped print substrate, which includes an image acquisition function of acquiring first image data and second image data, a halftone switching function of switching between a dither method and an error diffusion method to be performed during halftone processing, a halftone processing function of subjecting the first image data and the second image data to the halftone processing, and an output function of causing the printing device to print a first image and a second image on the print substrate in this sequence, wherein the first image and the second image are arranged adjacent to each other in a transporting direction of the print substrate, and the first and second images are formed by subjecting the first and second image data to the halftone processing, respectively. Further, the halftone processing function controls an initializing procedure for the second image data during the halftone processing, on the basis of a combination of the respective switched methods for the first image data and the second image data.

As described above, the print control program causes the halftone processing function to switch between the dither method and the error diffusion method to be performed during the halftone processing, in order to print on a long sheet-shaped print substrate. In addition, the halftone processing function controls an initializing procedure for the second image data during the halftone processing, on the basis of a combination of the respective switched methods for the first image data to be printed first and the second image data to be printed second and adjacent to the first image data. Since the initializing procedure is controlled on the basis of the combination of the dither method and the error diffusion method during the halftone processing, the initializing procedure can be omitted, for example, when the combination of the methods makes the initializing procedure decrease the process speed. This prevents the throughput of the entire printing processing from being deteriorated.

### BRIEF DESCRIPTION OF THE DRAWINGS

The invention will be described with reference to the accompanying drawings, wherein like numbers reference like elements.

FIG. 1 is a block diagram depicting a structure of a print system that includes a print control device according to an embodiment of the invention.

FIG. 2 is a view schematically depicting an internal structure of a printer in the print system.

FIG. 3 is a block diagram depicting a configuration of software in the print system.

FIG. 4 is a view depicting an example of images printed on a sheet.

FIG. 5 is a flowchart depicting processing of generating print data by using the print control device.

FIG. 6 is a flowchart depicting the detail of halftone processing.

FIG. 7 is a view depicting an exemplary case where the halftone processing is applied to images of standard and high qualities.

FIG. 8 is a flowchart depicting the detail of cut control processing.

FIG. 9 is a view depicting an example of a cut interval of each image printed on a sheet.

### DESCRIPTION OF EXEMPLARY EMBODIMENTS

A description will be given below of a print control device according to an embodiment of the invention, with reference to the accompanying drawings.

### System Configuration

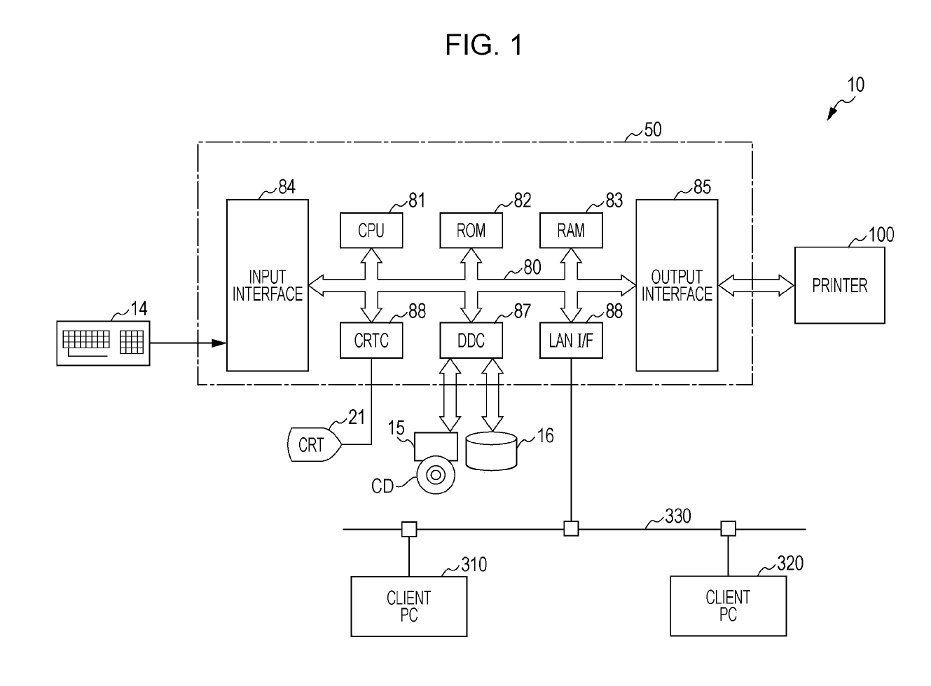

A description will be given below of a configuration of a print system having a print control device according to an embodiment of the invention. FIG. 1 is a block diagram depicting a configuration of a print system that has a print control device according to an embodiment of the invention. Referring to this figure, a print system 10 includes multiple client personal computers 310 and 320 (hereinafter, called “client PCs”), a computer 50 for printing, a local area network 330 (hereinafter, called a “LAN”) that connects the respective client PCs 310 and 320 to the computer 50, and a color printer 100 that is connected to the computer 50 (hereinafter, called a “printer”).

The client PCs 310 and 320 are placed, for example, in shops, such as those called “print lab stations”. In addition, each client PC functions as a terminal for ordering a photographic print through the operation of a user who wishes to print a picture. Note that each of the client PCs 310 and 320 may be either a general-purpose personal computer or a dedicated terminal for facilitating the input of a photographic image. An order for a photographic print which has been entered from the client PC 310 or 320 is transmitted to the computer 50 through the LAN 330. Note that although two client PCs are used in this embodiment, the number of multiple client PCs is not limited to two. Alternatively, a single client PC may be used instead of multiple client PCs. In addition, the LAN 330 may be either a wired LAN or a wireless LAN.

The computer 50 functions as a print control device, which controls the printer 100 by loading and executing a predetermined program. This computer 50 mainly includes a CPU 81, a ROM 82 and a RAM 83 for executing various computing processes in accordance with the program, along with the following units connected to one another through a bus 80. An input interface 84 controls the input of signals from a keyboard 14 or some other input device. An output interface 85 controls the output of data to the printer 100. A CRTC 86 controls the output of signals to a CRT 21 capable of displaying color images. A disk controller (DDC) 87 controls the transfer of data among a hard disk 16, a CD-ROM drive 15, and a flexible disk drive (not shown). On the hard disk 16, various programs to be loaded into the RAM 83 and executed therein, as well as other programs in the formats of device drivers are stored.

Furthermore, a LAN interface (LAN I/F) 88 is connected to the bus 80. This LAN I/F 88 is an interface for connecting the bus 80 and the LAN 330.

The printer 100 is a roll paper inkjet printer. This printer 100 has a head provided with multiple nozzles for discharging inks, and performs a main scan by reciprocating the head in the directions perpendicular to the long side of the roll of paper (or in the transporting direction), as well as a sub scan by displacing the head relative to the roll of paper in the lengthwise direction, in order to print an image. From the computer 50 to the printer 100, print data, such as raster data, that specifies at which pixels the nozzles are to create dots during the main scan is output. In accordance with this print data, the printer 100 performs the main and sub scans to thereby print photographic images on the roll of paper in series. Moreover, the printer 100 is provided with a cutting device (described later), and therefore, can cut out each of the printed photographic images on the roll of paper. Internal Structure of Printer

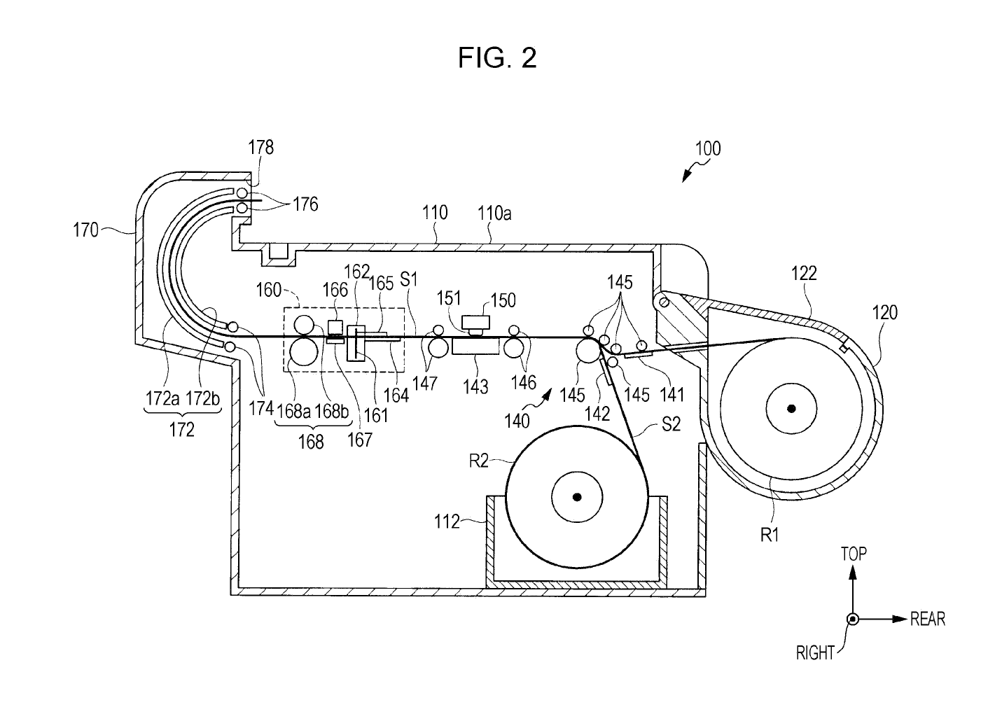

Next, a description will be given below of an internal structure of the printer 100. FIG. 2 is a view schematically depicting an internal structure of the printer 100. Referring to this figure, the printer 100 includes a printer main body 110, a paper feeding device 120 located at the rear of the printer main body 110, and a paper ejecting device 170 located at the front of the printer main body 110. The printer main body 110 has a structure in which a sheet S1, or a roll of paper, is inserted into the paper feeding device 120 on the rear side, and this sheet S1 is ejected towards the paper ejecting device 170 on the front side. The paper feeding device 120 has a roll body housing section 122 capable of housing a roll body R1 formed by winding the sheet S1 around a core so as to form a rolled shape. When the roll body R1 rotates about the axis of the core, the sheet S1 is released from the roll body housing section 122, and is transported toward the downstream side in the transporting direction.

On the downward outer side of the printer main body 110, a door (not shown) is provided. On the inner side of this door, a tray 112 for containing a roll body R2 formed by rolling a sheet S2, which is a long sheet-shaped print substrate, is placed, similarly to the roll body housing section 122. When the roll body R2 contained in the tray 112 rotates about the axis of a core thereof, the sheet S2, or a roll of paper, is released from the roll body housing section 122, and is transported toward the downstream side in the transporting direction.

Once released from the roll bodies R1 and R2, respectively, the sheets S1 and S2 are fed to the transporting mechanism 140. It should be noted that either of the roll bodies R1 and R2 may be called a “roll body R”, and either of the sheets S1 and S2 may be called a “sheet S” in this embodiment, for convenience of explanation.

The transporting mechanism 140 includes a first plate 141 and a second plate 142: the first plate 141 receives the sheet S1 in the transporting direction, which has been released from the roll body R1 within the roll body housing section 122; and the second plate 142 receives the sheet S2 in the transporting direction, which has been released from the roll body R2 within the tray 112. This transporting mechanism 140 further includes multiple transporting rollers 145, a transporting roller pair 146, and a transporting roller pair 147. These rollers are arranged along the transporting routes of the sheets S1 and S2, in order to transport the sheets S1 and S2 to a support plate 143. This transporting mechanism 140 switches between the respective transporting routes of the sheets S1 and S2, thereby transporting either one of the sheets S1 and S2 to the support plate 143.

The support plate 143 has a shape of a flat plate, and supports the sheet S fed by the transporting mechanism 140. Above and opposite the support plate 143, a carriage 150 is provided. This carriage 150 can reciprocate in directions that intersect the transporting direction of the sheet S, namely, in the lateral directions with respect to the transporting direction, by means of a driving mechanism (not shown). On the lower surface of this carriage 150, a head 151 is mounted. The lower surface of the head 151 forms a level nozzle surface on which nozzles (not shown) for discharging inks from openings thereof are arranged. The head 151 prints images on the sheet S by discharging inks onto the sheet S that is being transported between the carriage 150 and the support plate 143.

The sheet S subjected to printing by the head 151 is fed to a cutting device 160. This cutting device 160 includes a cutter carriage 162, a sheet guide 164, a cutting plate 165, a paper foot 166, a pressure-receiving plate 167, and an ejection roller pair 168. Specifically, the cutter carriage 162 is provided with a rotary cutter 161 (hereinafter, called a “cutter blade”). The sheet guide 164 guides the sheet S to the cutter blade 161. The cutting plate 165 supports the sheet S, while the cutter blade 161 cuts the sheet S. The paper foot 166 presses the sheet S, while the sheet S is cut. The pressure-receiving plate 167 is placed opposite the paper foot 166. The above-mentioned cutter blade 161, paper foot 166, and ejection roller pair 168 are arranged in this order in the downstream direction or the transporting direction.

### Software Configuration

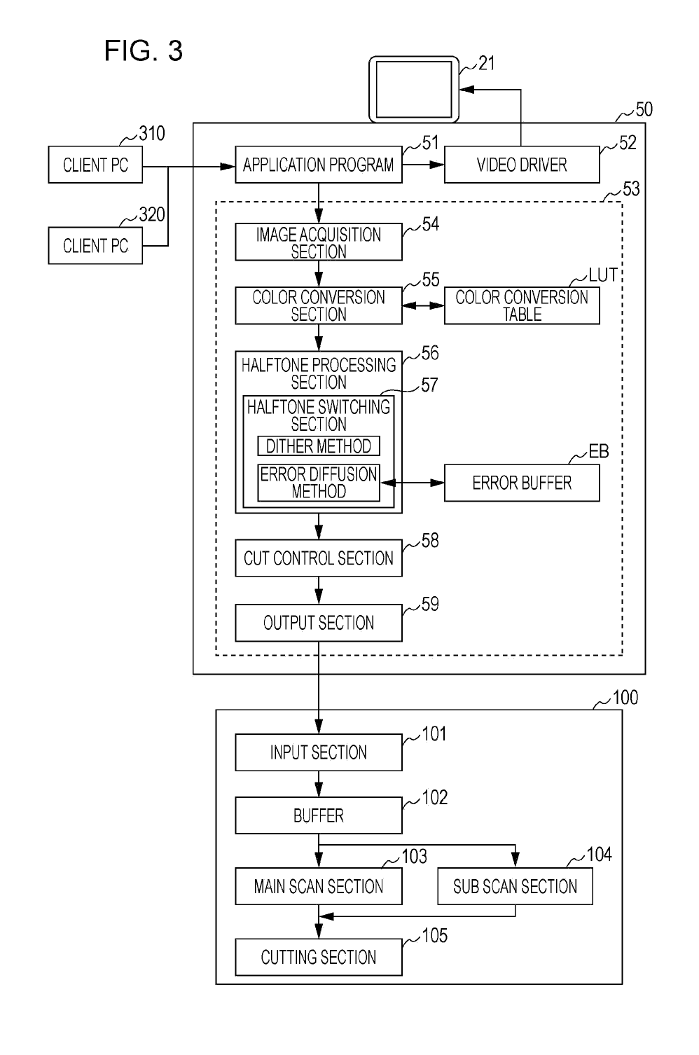

Next, a description will be given below of a configuration of software in the print system 10. FIG. 3 is a block diagram depicting a configuration of software in the print system 10. In the computer 50, an application program 51 operates under a predetermined operating system. The application program 51 receives image data transmitted from the client PC 310 or 320. The operating system contains a video driver 52 and a printer driver 53, and from the application program 51, the image data which is to be forwarded to the printer 100 through these drivers is output. The application program 51 generates images to be printed on the sheet S, in accordance with an instruction from the keyboard 14 or some other input device, and displays the generated images on the CRT display 21 through the video driver 52. The image data generated by the application program 51 is configured from data composed of three color (red (R), green (G) and blue (B)) components.

The printer driver 53 includes therein an image acquisition section 54, a color conversion section 55, a halftone processing section 56, a cut control section 58, and an output section 59. In response to the printing instructions from the application program 51, the image acquisition section 54 acquires the image data from the application program 51. The color conversion section 55 corrects the acquired image data in accordance with a preset color conversion table LUT. Specifically, the color conversion section 55 converts the R, G and B components of the image data into color components (cyan, magenta, yellow and black in this embodiment) that the printer 100 can express.

The halftone processing section 56 has a halftone switching section 57, which switches between the dither method and the error diffusion method in halftone processing, on the basis of the content of the image data. The halftone processing section 56 sets ON/OFF of a dot at each pixel during the halftone processing employing either of the dither method and the error diffusion method which the halftone switching section 57 has switched to, for the purpose of expressing the tone values of the corrected image data. Note that when the halftone processing employing the error diffusion method is performed, errors are prone to being generated at respective pixels. Accordingly, the halftone processing section 56 stores these errors in an error buffer EB.

The cut control section 58 generates a command for causing the cutting device 60 of the printer 100 to cut the sheet S along the width thereof, namely, in the direction that intersects the transporting direction. In this case, the cut control section 58 sets cut positions in the transporting direction, in accordance with the halftone processing applied to image data.

The output section 59 serializes the pieces of print data for each raster, in accordance with the sequence in which the head 151 is to output the pieces of print data in the directions of the main scan. In addition, the output section 59 re-generates the print data, such that the images that have been subjected to the halftone processing are to be printed adjacent to one another on the sheet S in the transporting direction. Moreover, the output section 59 adds the information on the number of sub scans in printing, and a command of designating the cut positions of the sheet S to the print data, and outputs this print data to the printer 100.

Meanwhile, the printer 100 includes an input section 101, a buffer 102, a main scan section 103, a sub scan section 104, and a cutting section 105. The input section 101 receives the print data output from the computer 50, and temporarily stores the received print data in the buffer 102. The data stored in the buffer 102 is output to the main scan section 103.

The main scan section 103 causes the head 151 to perform the main scan while discharging inks onto the sheet S, in accordance with the print data. After the main scan section 103 creates a raster on the sheet S, the sub scan section 104 transports the sheet S, in accordance with the information on the number of sub scans contained in the print data. Once the sub scan section 104 has transported the sheet S, the cutting section 105 cuts the sheet S, in accordance with the command of designating the cut positions contained in the print data. In this embodiment, the sheet S is cut along the width thereof.

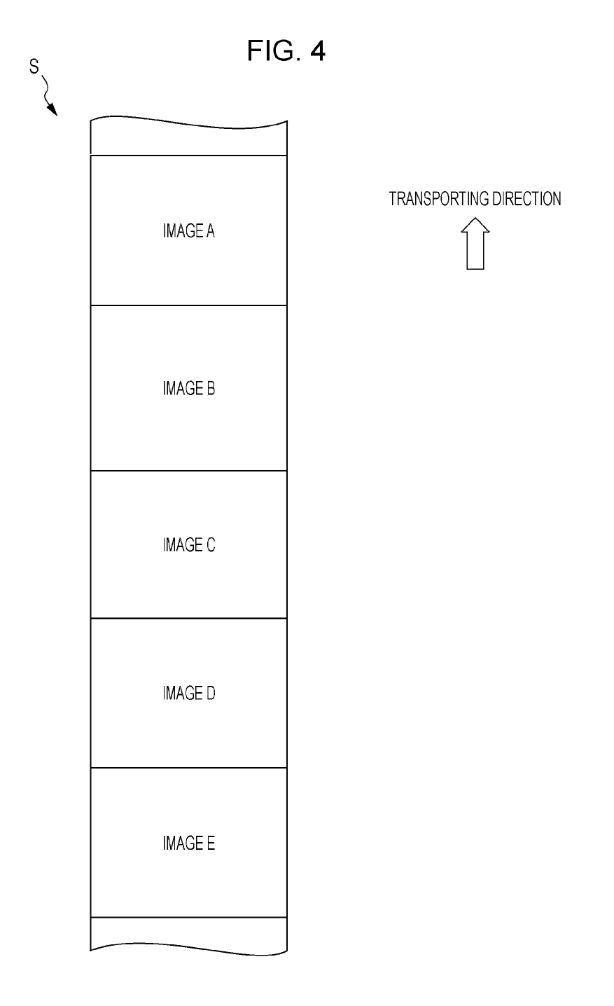

FIG. 4 is a view depicting an example of images printed on the sheet S. In this embodiment, when the head 151 performs the main scan while discharging inks onto the sheet S that is being transported, images A, B, C, D and E are printed on the sheet S in this order, with respect to the transporting direction. As shown in FIG. 4, the images A, B, C, D and E are arranged adjacent to one another without any margins in between. Moreover, the cutting device 60 of the printer 100 cuts the sheet S in the sequence of the images A to E. Specifically, the cutting device 60 cuts the area in the vicinity of the borders of adjacent images twice, creating a predetermined cut interval between the images in the transporting direction. Consequently, the images A to E are separated from one another, so that each of the images becomes an independent image sheet. Assuming a printed image as a first image, and the following printed image located adjacent to the previously printed image in the transporting direction as a second image, the images A and B in the example of FIG. 4 become the first and second images, respectively. Likewise, if the above assumption is applied to the combination of the images B and C of FIG. 4, then the images B and C become first and second images, respectively. The same can be applied to the combinations of the images C and D and the images D and E. In this embodiment, the data on the first image is the first image data, and the data on the second image is the second image data.

### Process of Generating Print Data

Next, a description will be given below of a process of generating the print data by using the computer 50.

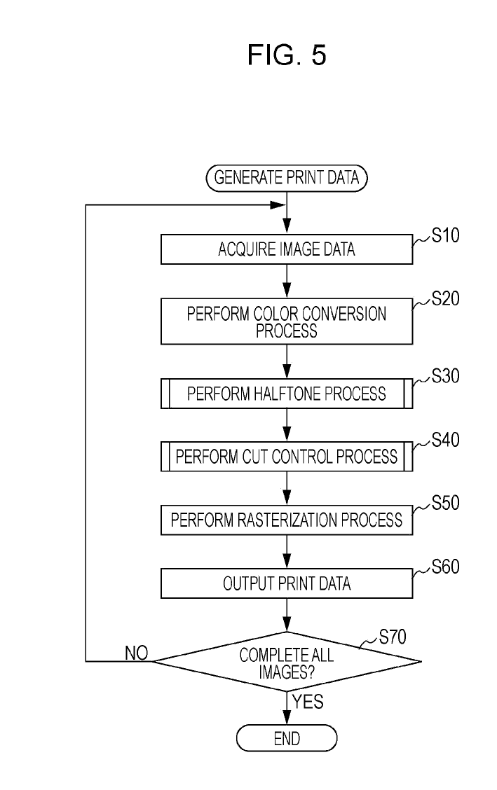

FIG. 5 is a flowchart depicting a process of generating the print data by using the computer 50. The process shown in this figure is performed by the CPU 81 (see FIG. 1) provided in the computer 50.

First, at a step S10, the CPU 81 causes the image acquisition section 54 to acquire image data output from the application program 51. This image data correspond to a single image to be printed on the sheet S, and is expressed by respective tone values for R, G and B.

At a step S20, the CPU 81 causes the color conversion section 55 to subject the image data acquired at the step S10 to color conversion processing. This color conversion processing corrects the image data by converting the color (R, G and B) components of the image data at every pixel into the color (C, M, Y and K) components which the printer 100 can express. This processing is performed in accordance with the color conversion table LUT for relating the color components C, M, Y and K to the hues R, G and B.

At a step S30, the CPU 81 causes the halftone processing section 56 to subject the image data, to which the color conversion has been applied at the step S20, to halftone processing employing the dither method or the error diffusion method.

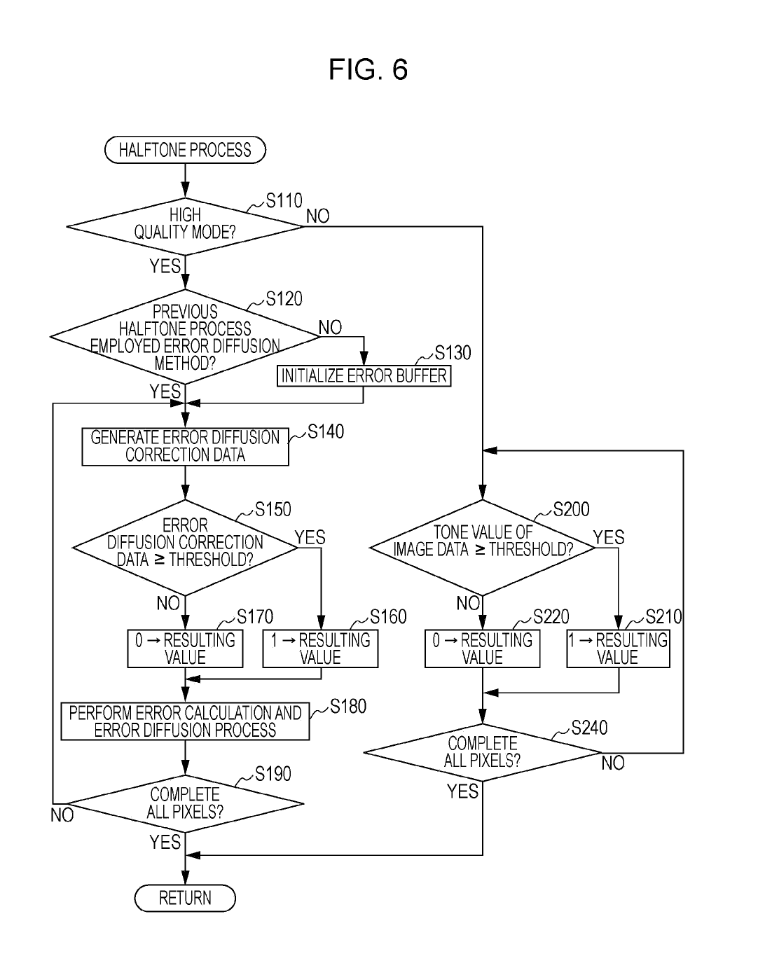

FIG. 6 is a flowchart depicting the detail of the halftone processing. First, at a step S110, the CPU 81 determines whether or not image data which is a target image for the halftone processing or has been subjected to the color conversion processing is in a high quality mode. If the image data is determined to be in a high quality mode (step S110: YES), then this processing proceeds to a step S120, and the halftone processing section 56 performs the error diffusion method. Otherwise, if the image data is determined not to be in a high quality mode (step S110: NO), then this processing proceeds to a step S200, and the halftone processing section 56 performs the dither method.

In this embodiment, the determination of whether or not the image data is in the high quality mode may be done in accordance with a user's setting. For example, if a user sets the print quality in print setting data to “high quality” through a certain interface, then the CPU 81 may determine that the image data is in a high quality mode. Otherwise, if the print quality is set as “standard quality”, then the CPU 81 may determine that the image data is not in a high quality mode. However, the determination of whether or not the image data is in the high quality mode is not limited to the above. Alternatively, the CPU 81 may determine that the image data is in a high quality mode, if the image data contains information regarding the expression of photographs.

At a step S120, the CPU 81 determines whether or not the previous image data has been subjected to the halftone processing employing the error diffusion method. In this case, the previous image data corresponds to the data of an image printed previously on the sheet S, when the printer 100 attempts to print newer image data on the sheet S. For example, in the example shown in FIG. 4, when the image data of the image B is to be subjected to the halftone processing, then the image data of the image A becomes the previous image data. In this case, the CPU 81 determines whether or not the image data of the image A has been subjected to the halftone processing employing the error diffusion method.

If it is determined that the previous image data has been subjected to the halftone processing employing the error diffusion method (step S120: YES), then this processing proceeds to a step S140 without initializing the error buffer EB. Otherwise, if it is determined that the previous image data has not been subjected to the halftone processing employing the error diffusion method, but has been subjected to the halftone processing employing the dither method (step S120: NO), then the CPU 81 initializes the error buffer EB (step S130), and then, this processing proceeds to a step S140.

In this embodiment, the error buffer EB stores density errors generated during the halftone processing employing the error diffusion method at respective pixels. The density error at each pixel is distributed to the neighboring pixels that have not yet been subjected to processing. Initializing the error buffer EB is to clear this density error, or diffusion error, to be distributed.

At a step S140, the CPU 81 generates error diffusion correction data for reflecting the diffusion errors in the image data, in order to determine ON/OFF of a dot at each pixel. The diffusion error is stored in the error buffer EB.

At a step S150, the CPU 81 determines whether or not the error diffusion correction data generated at the step S140 is equal to/more than a predetermined threshold. If the error diffusion correction data is determined to be equal to/more than the threshold (step S150: YES), then the CPU 81 determines that a dot is to be created, and enters “1” into a resulting value containing the determination result (step S160). In this case, the value “1” represents creation of a dot. Otherwise, if the error diffusion correction data is determined to be less than the threshold (step S150: NO), then the CPU 81 determines that a dot is not to be created, and enters “0” into a resulting value (step S170). In this case, the value “0” represents non-creation of a dot. In this embodiment, the threshold is a reference value for determining ON/OFF of a dot, and is not limited to a specific value.

At a step S180, the CPU 81 performs an error calculation and error diffusion processing, on the basis of the resulting value obtained at the step S160 or S170. In this case, the error indicates the difference in density between an image to be described at a target pixel, when a dot is rendered ON or OFF as the result from the multi-valued processing, and an image to be expressed on the basis of the error diffusion correction data. When a dot is created at a target dot, the density to be expressed is determined on the basis of a density evaluation value that has been preset for each pixel. The error diffusion processing is processing to weight the error at a target pixel that has been determined in the above manner, and to distribute the weighted error to neighboring pixels that have not yet been subjected to processing. This error is temporarily stored in the error buffer EB, and is used next time pixels are to be subjected to processing, namely, in the processing where the error diffusion correction data is generated at the step S140.

At a step S190, the CPU 81 determines whether or not all the pixels have been subjected to the halftone processing employing the error diffusion method. If it is determined that the processing has been completed for all the pixels (step S190: YES), then the CPU 81 terminates the halftone processing. If it is determined that all the pixels have not yet been subjected to the processing (step S190: NO), then the CPU 81 repeats the processing from the step S140.

On the other hand, in the processing from a step S200, the CPU 81 performs halftone processing employing the dither method. At a step S200, the CPU 81 determines the more or less relationship between each tone value of the image data and a predetermined threshold. If each tone value of the image value is determined to be equal to/more than the threshold (step S200: YES), then the CPU 81 determines that a dot is to be created, and enters “1” into a resulting value containing a determination result (step S210). In this case, the value “1” represents creation of a dot. Otherwise, if each tone value of the image value is determined to be less than the threshold (step S200: NO), then the CPU 81 determines that a dot is not to be created, and enters “0” into the resulting value (step S220). In this case, the value “0” represents non-creation of a dot.

The above-mentioned threshold is given by a dither matrix corresponding to the related pixels in a specific arrangement. In the dither method, the tone value of the image data at a pixel is compared to the threshold of the dither matrix corresponding to each pixel, and the ON/OFF of a dot at the pixel is determined.

At a step S240, the CPU 81 determines whether or not all the pixels have been subjected to the halftone processing employing the dither method. If it is determined that all the pixels have been subjected to the halftone processing employing the dither method (step S240: YES), then the CPU 81 terminates this halftone processing. Otherwise, if it is determined that all the pixels have not yet been subjected to the processing (step S200: NO), then the CPU 81 repeats the processing from the step S200.

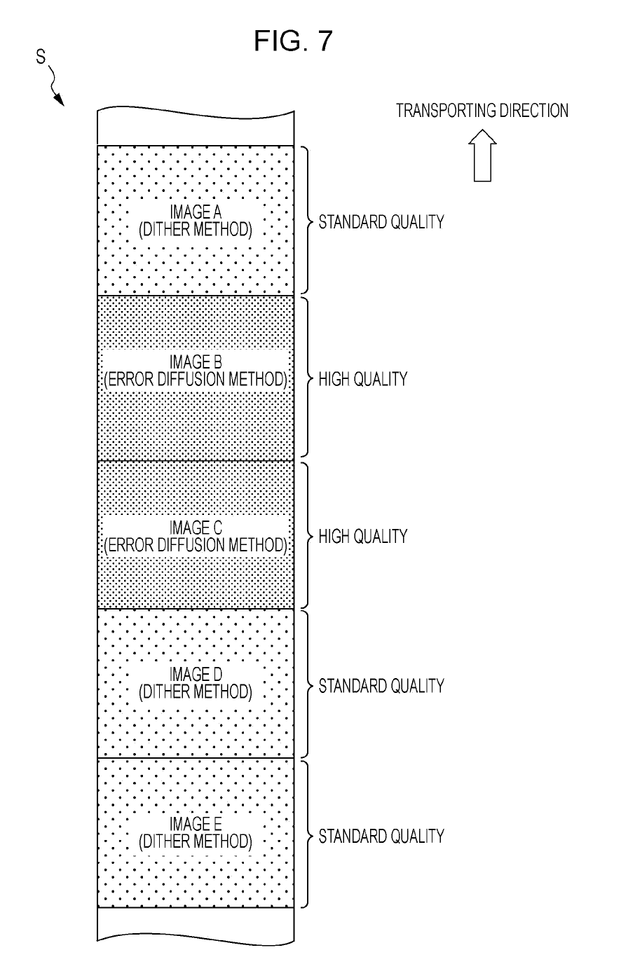

FIG. 7 is a view depicting an exemplary case where the halftone processing is applied to images of standard quality and high quality. The arrangement shown in this figure is similar to that of the images A to E in FIG. 4. Referring to FIG. 7, since the images B and C are of high quality, these images have been subjected to the halftone processing employing the error diffusion method. Meanwhile, since images A, D and E are of standard quality, these images have been subjected to the halftone processing employing the dither method.

In this example, the halftone processing employing the error diffusion method has been applied consecutively to the images B and C. Thus, the image B, which is the process target prior to the image C, has been subjected to the halftone processing employing the error diffusion method. Due to this, the error buffer EB is not initialized, before the halftone processing employing the error diffusion method is applied to the image C. Meanwhile, the image A of standard quality, which is a process target prior to the image B, has been subjected to the halftone processing employing the dither method. Accordingly, the error buffer EB is initialized, before the halftone processing employing the error diffusion method is applied to the image B.

Referring to FIG. 5 again, the CPU 81 causes the cut control section 58 to set cut positions on the image data having been subjected to the halftone processing at the step S30 which the cutting device 60 of the printer 100 is to cut, and generates a command for cutting the sheet S.

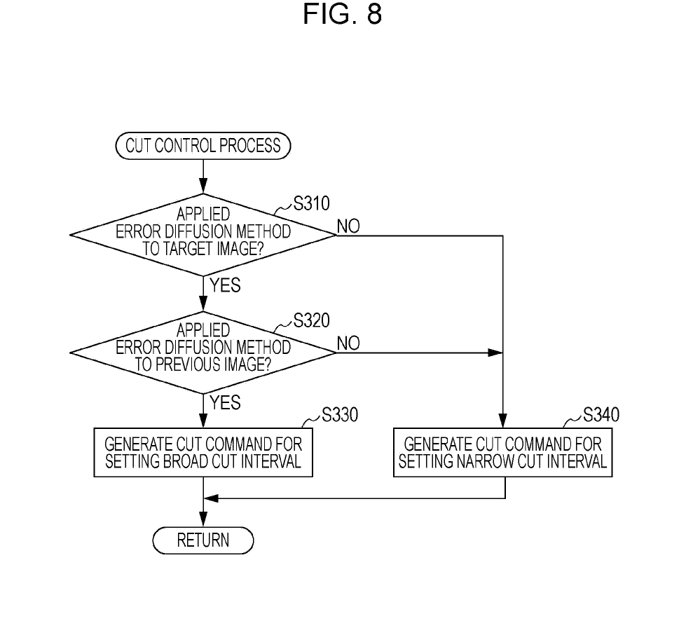

FIG. 8 is a flowchart depicting the detail of a cut control process. Specifically, the cut control processing sets two cut positions in the vicinity of the border of the respective adjacent images on the sheet S, in order to create a predetermined cut interval between the cut positions and, then generates a cut command. In this procedure, there are two cases where the cut intervals are broad and narrow. Note that as for the first image on the sheet S, namely, an image having no preceding printed image, and the last image on the sheet S, namely, an image having no following printed image, a single position on the side having no adjacent image may be set.

In this cut control process, at a step S310, the CPU 81 determines whether or not the halftone processing applied to an image has employed the error diffusion method. If it is determined that the error diffusion method has been employed (step S310: YES), then the processing proceeds to a step S320. Otherwise, if it is determined that the error diffusion method has not been employed, namely, that the dither method has been employed (step S310: NO), then the processing proceeds to a step S340. At the step S340, the cut control section 58 generates a cut command for setting a narrow cut interval, and terminates the cut control process.

At a step S320, the CPU 81 determines whether or not the halftone processing applied to the previous target image has employed the error diffusion method. If it is determined that the error diffusion method has been employed (step S320: YES), then the processing proceeds to a step S330. At the step S330, the cut control section 58 generates a cut command for setting a broad cut interval, and terminates the cut control process. Otherwise, if it is determined that the error diffusion method has not been employed, namely, that the dither method has been employed (step S320: NO), then the processing proceeds to the step S340. At the step S340, the cut control section 58 generates a cut command for setting a narrow cut interval, and terminates the cut control process.

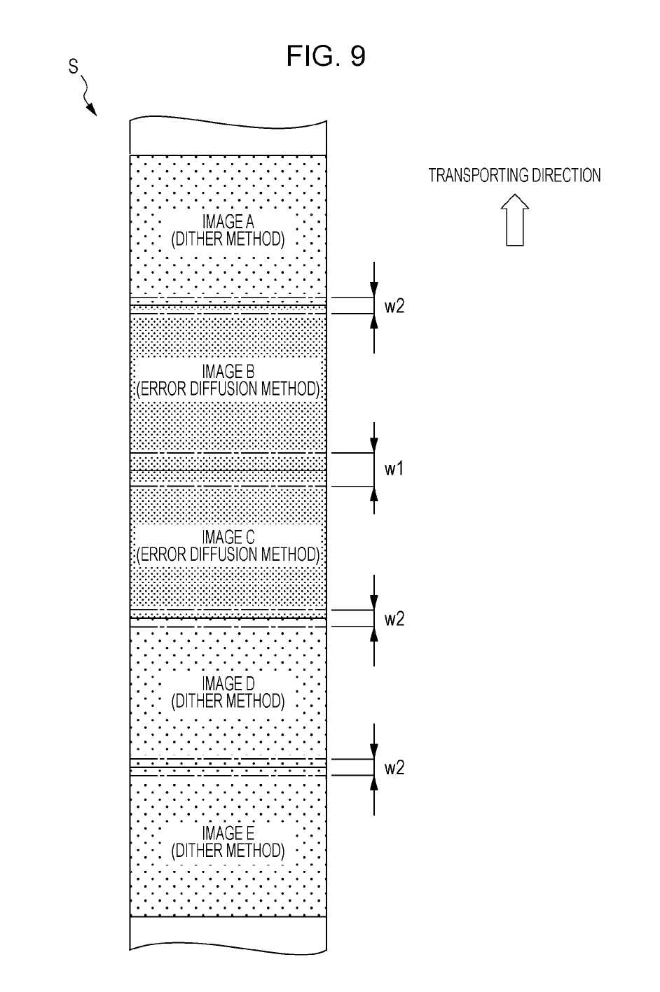

FIG. 9 is a view depicting an example of a cut interval of each image printed on the sheet S. The arrangement shown in this figure is similar to that of the images A to E in FIG. 7. Referring to FIG. 9, since the halftone processing employing the error diffusion method is applied to both the images B and C, a broad cut interval w1 is set in the vicinity of the border thereof. Meanwhile, since the halftone processing employing the error diffusion method is not applied consecutively to the combinations of the images A and B, the images C and D, and the images D and E, narrow cut intervals w2 are set in the vicinities of the respective borders thereof.

Referring to FIG. 5 again, at a step S50, the CPU 81 causes the output section 59 to serialize the pieces of image data which have been subjected to the cut control processing at the step S40, in accordance with the sequence of forwarding the pieces of the image data to the printer 100, and to rasterize the serialized piece of image data. At a step S60, the CPU 81 causes the output section 59 to output the rasterized print data to the printer 100. At a step S70, the CPU 81 determines whether or not all the images have been subjected to the above-mentioned processing. If it is determined that the processing has been completed for all the images (step S70: YES), then the CPU 81 terminates the process of generating the print data. Otherwise, if it is determined that all the images have not yet been subjected to the processing (step S70: NO), then the CPU 81 repeats the processing from the step S10.

Note that an image acquisition step and an image acquisition function herein correspond to the process of the step S10 in FIG. 5. A halftone switching step and a halftone switching function herein correspond to the process of the step S110 in FIG. 6. A halftone processing step and a halftone processing function herein correspond to the process of the step S30 in FIG. 5. An output step and an output function herein correspond to the steps S50 and S60 in FIG. 5.

As described above, the print system 10 of this embodiment determines whether or not the image is in a high quality mode, before printing an image on a long sheet-shaped substrate, such as a roll of paper. If the image is determined to be in a high quality mode, then the print system 10 performs the halftone processing employing the error diffusion method, as shown in FIG. 7. Otherwise, if the image is determined not to be in a high quality mode, then the print system 10 performs the halftone processing employing the dither method. Consequently, if a printed image of high quality is necessary, the print system 10 employs the error diffusion method, thereby providing a printed image of high quality. On the other hand, if a printed image of high quality is unnecessary, the print system 10 employs the dither method, thereby increasing the printing speed.

Furthermore, when images to which the halftone processing employing the error diffusion method is to be applied are arranged consecutively, as in the case of the images B and C in FIG. 7, the print system 10 does not initialize the error buffer EB in the halftone processing for the latter image (image C of FIG. 7). This enables the print system 10 to print images faster than when initializing the error buffer EB for each image, thereby enhancing the throughput of the entire print processing.

Moreover, when images which have been subjected to the halftone processing employing the error diffusion method are arranged consecutively, the print system 10 sets a cut interval w1 that is broader than a cut interval w2, as illustrated in the vicinity of the border of the images B and C in FIG. 9. This makes it possible to prevent the error generated upon printing the former image (image B of FIG. 9) from affecting the print quality of the latter image (image C of FIG. 9), even when images which have been subjected to the halftone processing employing the error diffusion method are arranged consecutively.

### Modification 1

In the print system 10 of the above-mentioned embodiment, the cut control section 58 of the computer 50 sets the cut positions at which the sheet S is to be cut, and generates a cut command. However, the embodiment of the invention is not limited to this configuration. Alternatively, the function of the cut control section 58 may be incorporated in the printer 100, instead of the computer 50. In this case, the printer 100 sets cut positions at which the sheet S is to be cut, on the basis of the print data received from the computer 50, and cuts the sheet S at the cut positions.

### Modification 2

In the above-mentioned embodiment, the sheet S of a long sheet-shaped print substrate is implemented by a roll of paper. However, the sheet S is not limited thereto. Alternatively, the sheet S is implemented by long paper in another form. In addition to this, the sheet S may be made of a film or some other material, instead of paper.

### Modification 3

In the above-mentioned embodiment, the sheet S contains the images A to E arranged consecutively and adjacent to one another without a margin in between in the transporting direction. However, the arrangement of images to be printed on the sheet S is not limited thereto. Alternatively, a margin of a predetermined width may be created between the printed images. In this case, it is preferable that a margin be created such that the center of the margin is located on the border of the images.

The entire disclosure of Japanese Patent Application No.2011-044790, filed Mar. 2, 2011 is expressly incorporated by reference herein.

What is claimed is:

1. A print control device which controls a printing device to print a plurality of images on a sheet-shaped print substrate, the print control device comprising:
an image acquisition section that acquires first image data and second image data;
a halftone switching section that switches between a dither method and an error diffusion method to be performed during halftone processing;
a halftone processing section that subjects the first image data and the second image data to the halftone processing; and
an output section that causes the printing device to print a first image and a second image on the print substrate in this sequence, the first image and the second image arranged adjacent to each other in a transporting direction of the print substrate, the first image formed by subjecting the first image data to the halftone processing, the second image formed by subjecting the second image data to the halftone processing,
wherein the halftone processing section controls an initializing procedure for the second image data during the halftone processing, on the basis of a combination of the respective switched methods for the first image data and the second image data.

2. The print control device according to claim 1,
wherein the halftone processing section skips the initializing procedure for the second image data during the halftone processing, if both of the switched methods for the first image data and the second image data are the error diffusion methods.

3. The print control device according to claim 2, further comprising a cut control section that causes the printing device to cut the print substrate in a direction that intersects the transporting direction,
wherein the cut control section causes the printing device to cut a border between the first and second images twice while reserving a predetermined interval in the transporting direction, and
wherein the predetermined interval is set to be larger than that set if the halftone processing section does not employ the error diffusion methods for both of the first image data and the second image data during the halftone processing.

4. The print control device according to claim 1,
wherein the halftone switching section switches to the error diffusion method if target image data for the halftone processing contains data to be printed with high quality, while the halftone switching section switches to the dither method if the target image data does not contain data to be printed with high quality.

5. A print control method of controlling a printing device to print a plurality of images on a sheet-shaped print substrate, the print control method comprising:
acquiring first image data and second image data;
switching between a dither method and an error diffusion method to be performed during halftone processing;
subjecting the first image data and the second image data to the halftone processing; and
causing the printing device to print a first image and a second image on the print substrate in this sequence, the first image and the second image arranged adjacent to each other in a transporting direction of the print substrate, the first image formed by subjecting the first image data to the halftone processing, the second image formed by subjecting the second image data to the halftone processing,
wherein during the halftone processing, an initializing procedure for the second image data is controlled on the basis of a combination of the respective switched methods for the first image data and the second image data.

6. A recording medium, having a print control program which controls a printing device to print a plurality of images on a sheet-shaped print substrate, the print control program comprising:
an image acquisition function of acquiring first image data and second image data;
a halftone switching function of switching between a dither method and an error diffusion method to be performed during halftone processing;
a halftone processing function of subjecting the first image data and the second image data to the halftone processing; and
an output function of causing the printing device to print a first image and a second image on the print substrate in this sequence, the first image and the second image arranged adjacent to each other in a transporting direction of the print substrate, the first image formed by subjecting the first image data to the halftone processing, the second image formed by subjecting the second image data to the halftone processing,
wherein the halftone processing function causes a computer to control an initializing procedure for the second image data, on the basis of a combination of the respective switched methods for the first image data and the second image data.
